(19) United States
(12) Patent Application Publication
(10) Pub. No.: US 2014/0281310 A1
(43) Pub. Date: Sep. 18, 2014

(54) Transforming a Shared Virtualized Space to an Enclosed Space

(71) Applicant: International Business Machines Corporation, Armonk, NY (US)

(72) Inventors: Khalid Filali-Adib, Austin, TX (US); J. Mark McConaughy, Austin, TX (US); Nathaniel S. Tomsic, Austin, TX (US); Sungjin Yook, Austin, TX (US)

(73) Assignee: INTERNATIONAL BUSINESS MACHINES CORPORATION, Armonk, NY (US)

(21) Appl. No.: 14/040,804

(22) Filed: Sep. 30, 2013

Related U.S. Application Data
(63) Continuation of application No. 13/838,346, filed on Mar. 15, 2013.

(51) Int. Cl. G06F 3/06

(52) U.S. Cl. CPC G06F 3/0665; G06F 3/067; G06F 3/0619
USPC 711/162

(57) ABSTRACT

Provided are techniques for allocating disk space for a virtualized file space; designating files within a global disk space as files to be privatized with respect to the virtualized file space; copying the designated files to the allocated disk space; storing an indicator specifying that the designated files have been copied; and in response to a startup of the virtualized file space subsequent to the allocating, designating and copying, detecting the indicator; and in response to detecting the indicator, redirect references in the virtualized file space to the designated files to the copied.

### CROSS-REFERENCES TO RELATED APPLICATIONS

The present application is a continuation and claims the benefit of the filing date of an application entitled, “Transforming a Shared Virtualized Space to an Enclosed Space” Ser. No. 13/838,346, filed Mar. 15, 2013, assigned to the assignee of the present application, and herein incorporated by reference

### BACKGROUND OF THE INVENTION

Unlike logical partitions (LPARs), in which computing resources are partitioned with respect to hardware, a virtualized the system is partitioned with respect to software. Unlike LPARs which may have different operating systems, virtualized file system spaces include virtualized operating system (OS) environments within a single instance of an OS. One example of a virtualized file system space, used as an example throughout this Specification, is a workload partition (WPAR). It should be understood that although the claimed subject matter is described with respect to WPARs, the same principles also apply to other types of virtualized file system spaces.

Basically, there are two types of WPARs, system WPARs and application WPARs. Typically, a system WPAR partitions system resources and an application WPAR isolates and executes one or more application processes. The following description is based upon system WPARs. Each WPAR has a regulated share of system resources and may have unique networks and file systems. In addition, each WPAR may have separate administrative and security domains, with each WPAR having a unique root user, regular users and passwords, its own services such as inetd, cron and syslog, and can be stopped and started on its own. A WPAR does not typically share writable file systems with other WPARs or the global system. WPARs share an operating system and may share underlying file systems, real or virtual disk adapters, processors, memory, paging space and a real or virtual network card.

Currently, a WPAR may be created in one of two types, a shared file system based WPAR or a private file system based WPAR. A shared WPAR has visibility over logical partition (LPAR) file systems, applications, binaries and libraries that reside in a global address space. Although this configuration may requires less disk space to operate because each user executes binaries installed in the global LPAR, installed binaries cannot be customized for a particular user. A private WPAR, which maintains isolated file systems, may require more disk space to operate but customization of installed packages is possible. Typically, a user must choose between one of the two types of WPARs when an WPAR is created. If a user who has established a shared WPAR determines that a private WPAR is preferable, a new WPAR must be created and data must be moved manually from the old WPAR to the newly created one.

### SUMMARY

As the Inventors herein have realized, there is currently no known way to transform a shared virtualized file system space to a private virtualized file system space and vice versa. For example, in a shared WPAR, users are not able to customize resources such as, but not limited to, /user and /opt directories by installing private file sets and/or programs. In addition, versioned WPAR, in which a WPAR is capable of running different versions of commands and libraries than the global environment, may not be possible in the context of a shared WPAR.

Provided are techniques for allocating disk space for a virtualized file space; designating files within a global disk space as files to be privatized with respect to the virtualized file space; copying the designated files to the allocated disk space; storing an indicator specifying that the designated files have been copied; and in response to a startup of the virtualized file space subsequent to the allocating, designating and copying, detecting the indicator; and in response to detecting the indicator, redirect references in the virtualized file space to the designated files to the copied.

This summary is not intended as a comprehensive description of the claimed subject matter but, rather, is intended to provide a brief overview of some of the functionality associated therewith. Other systems, methods, functionality, features and advantages of the claimed subject matter will be or will become apparent to one with skill in the art upon examination of the following figures and detailed description.

### BRIEF DESCRIPTION OF THE DRAWINGS

A better understanding of the claimed subject matter can be obtained when the following, detailed description of the disclosed embodiments is considered in conjunction with the following figures, in which:

FIG. 1 is a block diagram of a computing system architecture that may implement the claimed subject matter.

FIG. 2 is a block diagram of a workload partition (WPAR) Command Processor (CP), introduced above in FIG. 1, in greater detail.

FIG. 3 is as flowchart of one example of a Modify WPAR process that may implement aspects of the claimed subject matter.

FIG. 4 is a flowchart of one example of a Start WPAR process that may implement aspects of claimed subject matter.

### DETAILED DESCRIPTION

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,”, “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable. RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational actions to be performed on the computer, other programmable apparatus or other devices to produce a computer implemented process such that the instructions which execute on the computer or other programmable apparatus provide processes for implementing the functions/acts specified in the flowchart and/or block diagram block or blocks. It should also be understood that, although described with respect to WPARs, the claimed subject matter is equally applicable to other types of virtualized file system spaces.

Turning now to the figures, FIG. 1 is a block diagram of one example of a computing system architecture 100 that may incorporate the claimed subject matter. A computing system 102 includes a central processing unit (CPU) 194, coupled to a monitor 106, a keyboard 108 and a pointing device, or “mouse,” 110, which together facilitate human interaction with computing system 100 and client system 102. Also included in client system 102 and attached to CPU 104 are computer-readable storage mediums (CRSMs), specifically a CRSM_{—}1 111, a CRSM_{—}2 112, CRSM_{—}3 113 and a CRSM_{—}4 114. Each of CRSM_{—}1 111-114 may either be incorporated into client system 102, i.e. an internal device, or attached externally to CPU 104 by means of various, commonly available connection devices such as but not limited to, a universal serial bus (USB) port (not shown).

CRSM_{—}1 111 is illustrated storing an operating system (OS) 116, a shared memory 118, a WPAR Command Processor (CP) 120 and a number of workload partitions, or WPARs, i.e. a WPAR_{—}1 121, a WPAR_{—}2 122 and a WPAR_{—}3 123. In the following examples, WPAR CP 120 is configured to implement the claimed subject matter. In addition, WPAR_{—}1 121 is a shared WPAR, able to accessed by multiple users of computing system 102 and/or other computing systems, and WPAR_{—}2 122 is as private WPAR, i.e. able to be accessed only by a single user. The implementation and coordination of WPARs 121-123, the conversion of WPARs 121 and 122 from shared to private and private to shared, respectively, are explained in more detail below in conjunction with FIGS. 2-4.

Computing system 102 is also coupled to the Internet 130, which is in turn coupled to two (2) other computing systems, i.e. a client 132 and a server 134. Although in this example, computing system 102 and computing, systems 132 and 134 are communicatively coupled via the Internet 130, they could also be coupled through any number of communication mediums such as, but not limited to, a local area network (LAN) (not shown). Computing devices 132 and 134 are used as examples of resources that mat be available to computing system 102 and serve as potential access points to computing system 102. It should be noted that a typical computing system would typically include many addition elements, but for the sake of simplicity only a few are shown.

FIG. 2 is a block diagram of WPAR CP 120, introduced above in FIG. 1, in greater detail. WPAR CP 120 includes an input/output (I/O) module 140, a data module 142, an allocation module 144, a de-allocation module 146, operation logic 148 and a user interface (UI) 150. Although there may be other components of WPAR CP 120, for the sake of simplicity, only components 140, 142, 144, 146, 148 and 150 are illustrated and described. For the sake of the following examples, WPAR CP 120 is assumed to execute on one or more processors (not shown) of computing system 102 (FIG. 1) and to be stored on CRSM_{—}1 111 (FIG. 1). It should be understood that the claimed subject matter can be implemented in many types of computing systems and data storage structures hut, for the sake of simplicity, is described only in terms of computing system 102 and system architecture 190 (FIG. 1). Further, the representation of WPAR CP 120 in FIG. 2 is a logical model. In other words, components 140, 142, 144, 146, 148 and 150 may be stored in the same or separates files and loaded and/or executed within computing system 102 and architecture 199 either as a single system or as separate processes interacting via any available inter process communication (IPC) techniques.

I/O module 149 handles any communication WPAR CP 120 has with other components of system 100. Data module 142 is a data repository for information and parameters that WPAR CP 120 requires during operation. Examples of the types of information stored in data module 142 include WPAR data 152, user data 154, system data 156 and option data 158.

WPAR data 152 stores information relating to established WPARs such as WPAR_{—}1 121, WPAR_{—}2 122 and WPAR_{—3} 123 including, but not limited, to, various resources that may be allocated to each of WPARs 121-123. User data 154 stores information on users of computing system 102 and architecture 100 and their relationship, if any, with LPARs 121-123 including, but not limited to, ID and passwords. System data 156 stored information about resources of computing system 102 and their relationship with LPARs 121-123. As explained above in the Background, each WPAR 121-123 may have separate administrative and security domains, with each having a unique root user, regular users and passwords, its own services such as inetd, cron and syslog, and can be stopped any started on its own. WPARs 121-123 may share operating system 116 (FIG. 1), underlying file systems 118 (FIG. 1), real or virtual disk adapters (not shown), processors (not shown), paging space (not shown) and a real or virtual network cards (not shown). Option data 158 stores user and administrative operating parameters that may control the operation of WPAR CP 120.

Allocation module 144 stores logic responsible for allocating memory of computing system 102 in accordance with the claimed subject matter. De-allocation module 146 stores logic responsible for the de-allocation of memory in accordance with the claimed subject matter. Operation logic 148 stores logic associated with implementation of the claimed subject matter as well as logic responsible for the typical operation of a WPAR CP such as WPAR CP 129 as understood by those with skill in the relevant arts.

UI 150 enables users of WPAR CP 120 to interact with and to define the desired functionality of WPAR CP 120, typically by setting various operating parameters in option data 158. Examples of functions that an administrator may implement via UI 159 are the discovery, creation, modification, deletion and removal of WPARs as well as the redefining of a public WPAR to a private LPAR in accordance with the claimed subject matter. Components 142, 144, 146, 148, 150, 152, 154, 156 and 158 are described in more detail below in conjunction with FIGS. 3-4.

FIG. 3 is a flowchart of one example of a Modify WPAR process 200 that may implement aspects of the claimed subject matter. In this example, process 200 is associated with logic stored on CRSM_{—}1 111 (FIG. 1) in conjunction with WPAR CP 120 (FIG. 1) and executed on one or more processors (not shown) of CPU 104 (FIG. 1) of computing system 102 (FIG. 1).

Process 200 begins in a “Begin Modify WPAR” block 292 and proceeds immediately to a “Receive Request” block 204. During, processing associated with block 204, a request to modify a WPAR such as one of WPARs 121-123 (FIG. 1) is received by process 200. Such a request is typically generated by a user or administrator who wants to convert a public WPAR, to a private WPAR in accordance with the claimed subject matter. During processing associated with an “Estimate Space” block 296, the available disk space on, in this example CRSM_{—}1 111 is checked to determine if enough disk space is available for the requested conversion. As explained above in the Background, less disk space is typically required for a public WPAR because a number of files are shared among users.

During processing associated with a “Space Adequate?” block 208, a determination is made as to whether or not the space estimated during processing associated with block 206 is sufficient to accomplish the request received during processing associated with block 204. If not, control proceeds to an “Add Disk Space” block 210. During processing associated with block 210, new disk space is allocated, using know disk allocation procedures, to the rootvg of the affected WPAR. For example, a request for additional disk space may be transmitted to OS 116 (FIG. 1) which would then bring one or more of CRSMs 112-114 (FIG. 1) online. Ii should be noted that while the allocation of new disk space and other actions described below are ongoing all processes within the virtual space may be kept alive and functioning normally.

Once sufficient disk space is available, either because a determination is made during processing associated with block 208 that enough is already available or disk space has been added during processing associated with block 210, control proceeds to a “Create Logical Volume (LV) and File Systems” block 212. During processing associated with block 212. LVs and directories are created for necessary directories such as, but not limited to, /usr and /opt. During processing associated with a “Copy Data” block 214, data is copied from the corresponding global file system to the newly created WPAR rootvg file systems created during processing associated with block 212. During this copy operation, a file lock is employed to prevent the installation of new filesets so that inconsistent or partially installed packages set of files are not created. The user of the affected WPAR is also notified of the additional disk space that was required for the conversion of the WPAR from public to private.

During processing associated with an “Install Indicator” block 216, an indicator, such as but not limited to a cookie, is stored in the WPAR space to indicate that a partial conversion has been completed. It should be understood that the conversion is only completed when the affected WPAR is restarted (see 250, FIG. 4). Finally, control proceeds to an “End Modify WPAR” block 219 in which process 200 is complete.

FIG. 4 is a flowchart of one example of a Start WPAR process 250 that may implement aspects of the claimed subject matter. Like process 200, in this example, process 250 is associated with logic stored on CRSM_{—}1 111 (FIG. 1) in conjunction with WPAR CP 120 (FIG. 1) and executed on one or more processors (not shown) of CPU 104 (FIG. 1) of computing system 102 (FIG. 1).

Process 250 begins in a “Begin Start WPAR” block 252 and proceeds immediately to a “Receive WPAR Request” block 254. During processing associated with block 254, a request is received by WPAR CP 120 to start a particular WPAR. It is assumed for the purposes of the following example that the particular WPAR is not currently active. During processing associated with a “Check Indicators” block 256, the WPAR space is scanned to detect the existence of any indicators (see 216, FIG. 3) that would signal that a partial conversion of the WPAR has been completed.

During processing associated with an “Indicator (Ind.) Located?” block. 258, a determination is made as to whether or not an indicator has been detected during processing associated with block 256. If so, control proceeds to a “Redirect Resources” block 260. During processing associated with block 260. the WPAR being started is directed to privatized file systems that have been established (see 212 and 214, FIG. 3) rather than the shared resources such as /usr and /opt of the global space. During processing associated with a “Redirect Successful? block 262, a determination is made as to whether or not the redirect of resources performed during processing associated with block 260 was successful. If not or, if during processing, associated with block 258, a determination is made that no indicators were detected, control proceeds to a “Direct Resources to Original” block 264. During processing associated with block 264, the WPAR is directed to the existing global shared resources such as /usr/ and /opt.

If, during processing associated with block 262, a determination is made that the redirect of block 260 was successful, control proceeds to an “Update Resources” block 266. During processing associated with block 266, any relevant references to the updated resources are modified to reference the new resources and the indicator is removed from the WPAR space. During processing associated with a “Notify User” block 268, the user is notified of the actions taken including a successful or unsuccessful redirection of resources. Finally, during processing associated with an “End Start WPAR” block 269, process 250 is completed.

The terminology used herein is for the purpose of describing particular embodiments only and is not intended to be limiting of the invention. As used herein, the singular forms “a”, “an” and the are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the an without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

The flowchart and block diagrams in the Figures illustrate the architecture, functionality, and operation of possible implementations of systems, methods and computer pro grain products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

We claim:

1. A method, comprising:
allocating disk space for a virtualized file space;
designating files within a global disk space as files to be privatized with respect to the virtualized file space;
copying the designated files to the allocated disk space;
storing an indicator specifying that the designated files have been copied; and
in response to a startup of the virtualized file space subsequent to the allocating, designating and copying, detecting the indicator; and
in response to detecting the indicator, redirect references in the virtualized the space to the designated files to the copied files.

2. The method of claim 1, further comprising:
generating logical volumes and directories in the allocated disk space; and
copying the designated files to logical volumes and directories in the allocated disk space;

3. The method of claim 2, wherein the generated directories include a user directory and a opt directory.

4. The method of claim 1, wherein ongoing processes in a global space associated with the virtualized file space remain functioning during the method.

5. The method of claim 1, further comprising locking the designated files in conjunction with copying the designated files to the allocated disk space.

6. The method of claim 1, wherein the virtualized file space is a workload partition.

7. The method of claim 1, wherein the indicator is a cookie stored in the virtualized file space.
